(19) United States
(12) Patent Application Publication
(10) Pub. No.: US 2009/0013568 A1
(43) Pub. Date: Jan. 15, 2009

(54) LUMINESCENT LICENSE PLATE AND METHOD TO USE SAME

(76) Inventor: John J. Kwak, Flushing, NY (US)

Correspondence Address: LUCAS & MERCANTI, LLP, 475 PARK AVENUE SOUTH, 15TH FLOOR, NEW YORK, NY, 10016, US

(21) Appl. No.: 11/776,074

(22) Filed: Jul. 11, 2007

(51) Int. Cl. G09F 13/16

(52) U.S. Cl. 40/208

(57) ABSTRACT

The present invention relates to a self-luminescent license plate and a method of using it for clearly discerning the identifying information on the license plate in environments with low visibility. It comprises a suitable luminescent material applying on the license plate to make the letters and numbers thereon more visible. This invention also relates to a regulation that requires the license plates to be luminescent treated. The invention is inexpensive and easy to apply, while provides benefits of improving traffic flow, reducing accidents and deterrence of hit-and-run.

### TECHNICAL FIELD OF THE INVENTION

The present invention relates in general to a self-luminescent license plate and a method of using it for clearly discerning the identifying information on the license plate in environments with low visibility.

### BACKGROUND OF THE INVENTION

From 1998 to 2001, there have been approximately 18,100 pedestrian fatalities attributed to single vehicle accidents across the United States. Approximately 18% of those fatalities were caused by hit-and-run accidents. A majority of these accidents have been unresolved due to the inability of law enforcement to identify the perpetrator. One factor contributing to this failure is the inability to clearly see the license plates of the vehicle involved in the accident. This is especially true when the accident occurs at night or when weather conditions affect the visibility of the environment. Therefore it is beneficial to both pedestrian and motorists to mandate precautionary measure to improve the visibility of the license plate.

Government-issued vehicle identification plates are typically plain painted plate with letters and numbers. Most of the cars now have electrically lighted license plates. For these conventional plates, they are lighted by lamps with electrical power for being visible in darkness. Reflective license plates are also being used. These plates reflect ambient light or other light sources available to them. However, these applications are trying to light up the whole plate and won't be helpful is there is no light available. As a result, these license plates may become difficult to discern either due to the time of night or inclement weather conditions.

There is thus a need for license plates with identification letters and numbers that emit their own light and that are inexpensive and easy to install and maintain.

### SUMMARY OF THE INVENTION

According to the invention, a luminescent means is applied on the license plate. This would allow law enforcement or any other witnesses to clearly discern the identifying information on the license plates, and make it easier to identify and pursue a hit-and-run suspect.

In one aspect of the invention, the luminescent material should be traced over all of the identifying information, such as letters and numbers, on all license plates. The applied luminescent material is protected by a layer of a relatively tough, rigid, weather-resistant material, such as an acrylic resin.

In another embodiment, the luminescent material is applied to the background surface of the license plate and leaves the letters and numbers uncovered. Hence the contrast color or darkness of those letters and numbers are clearly discernable in low visible conditions.

In a further embodiment, luminescent labels of 26 alphabetical letters and 10 Arabic numbers are provided to be applied on the license plate. The separate step and material cost of painting an individual plate is avoided.

### BRIEF DESCRIPTION OF THE DRAWINGS

Further aspects of the invention and their advantages may be better understood from the following description when taken in conjunction with the drawings in which:

FIG. 1 is a front plan view of the license plate of the present invention with the identifying information illuminated;

FIG. 2 is a front plan view of the license plate of the present invention with background part illuminated while the identifying information is unilluminated;

FIG. 3 is a perspective view of a luminescent label being applied on a license plate according to the present invention; and

FIG. 4 is a perspective view of a vehicle with the license plate of this invention installed.

### DETAILED DESCRIPTION

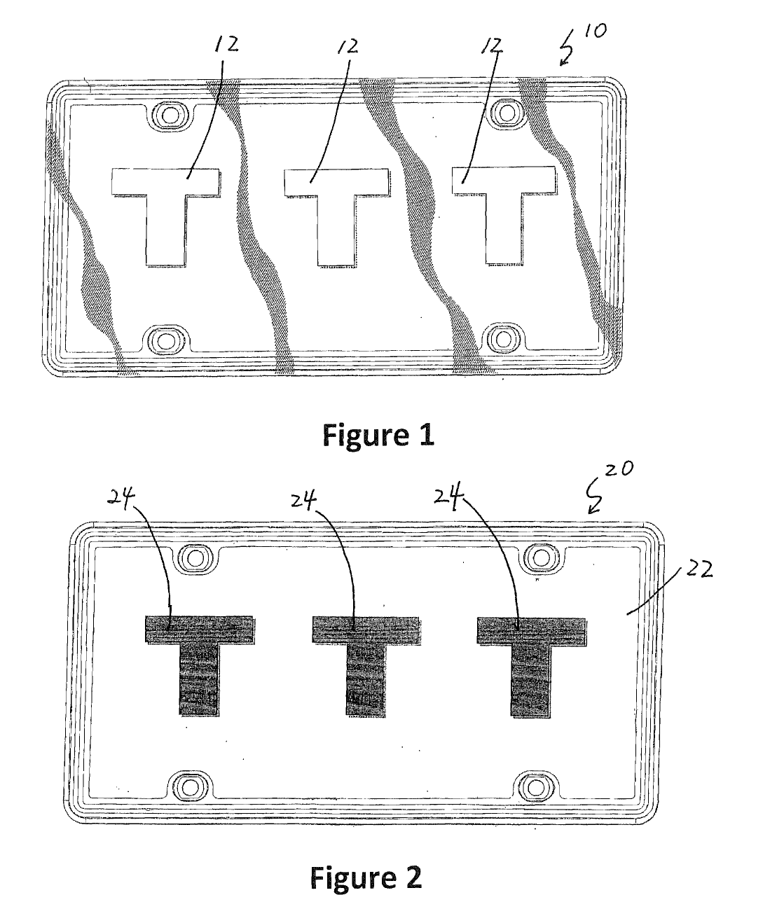

FIG. 1 illustrates luminescent plate 10, where identifying information 12 thereon have been covered with luminescent material, such as luminescent paint. The composition of luminescent paint are those paints with the capacity of being exposed to light, either natural or artificial, for a specific minimum amount of time, then giving off light for a measurable amount of time and level of luminosity.

In general, the luminescent pigments used in these and other such devices provide a certain amount of light after they in turn have been exposed to light for a certain period. Examples of luminescent pigments include, among others, zinc sulfide and alkali metal oxide aluminates. Phosphorescent paint incorporating phosphor providing light emission in bright yellows and reds can also be used. A typical phosphorescent pigment includes an alkali earth (barium, calcium, strontium) oxide aluminate pigment of acceptable color and particle size is available under the trademark LUMINOVA, by United Mineral and Chemical Corporation, from New Jersey.

This embodiment can further comprise a set of stencil with 26 English alphabetical letters and 10 Arabic numbers cutoff to receive the luminescent paint. The stencil is attached to the surface by some form of attachment: tack, clip, tape, etc, or simply by holding it in place by hand. The luminescent paint can be applied by brush, roller or spray device, such as aerosol paints.

An alternative embodiment depicted in FIG. 2 is to apply the luminescent material to background portion 22 of plate 20 instead of on identifying information 24, such as the letters and numbers themselves. The contrast provides by the lighting of background and the unlighted identifying information 24 give more visibility to the identifying information on the plate. The usual surface preparation typical for paint application is required for background 22.

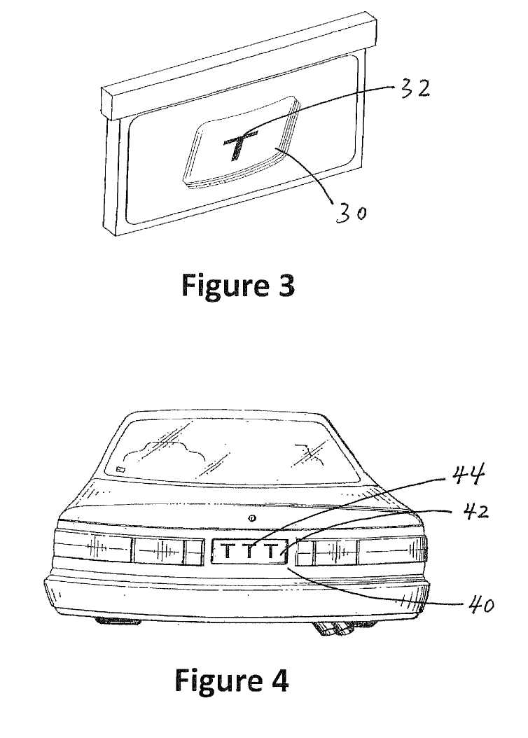

Another embodiment shown in FIG. 3 relates to luminescent labels 30 precut for identifying information 32, such as 26 English letters and 10 Arabic numbers, preprinted with luminescent material. For example, the identifying information on a license plate in Connecticut comprises smaller letters of “CONNECTICUT”, three numbers and three capitalized letters. These luminescent letters and numbers are selected based on the size and font and attached to the respective letters or numbers on the plate. These labels with luminescent letters and numbers can be made of luminescent sheet material or PVC.

In particular, the label is adhesive backed and may have two layers of polyvinyl sheets precut with identifying information 32 corresponds with the size and shape of the letters and numbers used in certain state. The first layer of polyvinyl sheet has a back layer of adhesive for attachment to a surface having a peel off cover and a front layer of printed luminescent paint on identifying information 32, such as the letters and numbers. A second layer of transparent polyvinyl plastics covers the luminescent layer for protection.

The license plates made in accordance with the invention will be bright enough to be visible in darkness. Suitable luminescent paints may comprise luminescent substance, such as phosphorescent or florescent materials having increased brightness and longer lasting afterglow, and an epoxy resin which imparts durability and longer life to the painted area. Alternative luminescent coatings, such as latex, can be used.

Moreover, the luminescent paint can be transparent or be tinted to match many commonly used colors as the non luminescent paint typically used for the license plates, so that the sign would be visible in an ordinary looking.

In addition to the easy recognition of the license information, luminescent license plate will have other ancillary benefits. For example, during inclement weather condition, a driver will be assisted by the luminescent plate to discern the distance between moving vehicles therefore preventing possible accident; in states where the vehicles have license plates on the front of the vehicles, the pedestrian will recognize the possible dangerous driving by on-coming vehicles even if their conventional plate lamps are off. Luminescent license plate will also helpful for indentifying the motorist in incidents whose plate lamps are not functional. These improvements will help quicken decision making process when motorist warned by the luminescent license plate early and therefore act properly. The fact is that better recognition of the plate number will reduce the chance of hit-and run drivers to run away unidentified, therefore these luminescent license plates will also have possible deterrent effects to prevent hit-and-runs.

However, individual drivers may be lack of incentive to change for luminescent plates. To achieve above benefits, the government should establish a regulation that requires all license plates to be luminescent treated according to this invention This invention will enable governmental personal to easily apply and maintain license plates that emit lights in a darkened scenario.

An example of using luminescent plates is illustrated in FIG. 4, where the luminescent background 42 of plate 40 makes identifying information 44 more visible.

The costs of the implementation of the regulation requiring the luminescent license plate are minimal since the cost of paints and labor for the painting or applying the luminescent labels are very low. The embodiments of this invention are all relatively inexpensive and easy to apply and require little maintenance.

In summary, a self-luminescent vehicle license plate and its usage has been described and illustrated by specific embodiments above. However, while the invention has been described with respect to the illustrated embodiment, it is not limited thereto, but only by the scope and spirit of the appended claims.

1. A luminescent license plate comprising:
a vehicle license plate having letters and numbers on a background portion;
a luminescent material applying on said license plate to make the letters and numbers thereon more visible in darkness; and
an acrylic resin layer on said luminescent material for protection;
where the luminescent material comprising fluorescent substance.

2. The luminescent license plate of claim 1, wherein the luminescent material is applied on the letters and numbers only.

3. The luminescent license plate of claim 1, wherein the luminescent material is applied on background portion of said license plate only.

4. The luminescent license plate of claim 1, wherein the luminescent material comprises a set of precut labels comprising
a peel off back layer;
a first layer of polyvinyl having a front side and a back side, said first layer precut with a letter or number corresponds with certain size and shape of one of the letters and numbers on said license plate;
a fluorescent paint printed on the front side covering at least said letter or number; and
a adhesive material applied on the back side of said first layer; and
wherein the acrylic resin layer comprises a second layer of a transparent polyvinyl covering the luminescent paint on said front side for protection.

5. A method of using the luminescent license plate of claim 1, comprising steps of
establishing a regulation requiring vehicle license plate to be luminescent;
issuing license plate with luminescent treatment by applying a fluorescent material with an acrylic resin layer for protection on said plate;
monitoring the using of said plate; and
maintaining said plate by reapplying a fluorescent material.

6. The method of using the luminescent license plate of claim 5, wherein applying and reapplying said fluorescent material on said plate is conducted using a set of plastic stencil with 26 English alphabetical letters and 10 Arabic numbers cutoff to receive a fluorescent paint.

7. The method of using the luminescent license plate of claim 5, wherein applying and reapplying said fluorescent material on said plate is conducted by using a set of precut labels comprising:
a peel off back layer;
a first layer of polyvinyl having a front side and a back side, said first layer precut with a letter or number corresponds with certain size and shape of one of the letters and number on said license plate;
a fluorescent paint printed on the front side covering at least said letter or number;
a adhesive material applied on the back side of said first layer; and
a second layer of a transparent polyvinyl covering the fluorescent paint on said front side for protection.
